(19) United States
(12) Patent Application Publication
(10) Pub. No.: US 2010/0037463 A1
(43) Pub. Date: Feb. 18, 2010

(54) Combination Shaving and Trimming Device

(76) Inventors: Michael Maichel, Frnakfurt (DE); Markus Schuessler, Koenigstein (DE); Ralf Klug, Eschborn (DE); Cirilo Javier Perez Lopez, Eschborn (DE); Andreas Larscheid, Kelkheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/543,337

(22) Filed: Aug. 18, 2009

Related U.S. Application Data
(60) Provisional application No. 61/089,641, filed on Aug. 18, 2008.

(51) Int. Cl. B26B 19/38; B26B 19/28; B26B 21/52; B26B 21/00

(52) U.S. Cl. 30/34.1; 30/45; 30/526; 30/50

(57) ABSTRACT

A combination shaving and trimming device includes a handle having an upper end and lower end, a powered trimmer disposed adjacent the upper end, a wet-shaving razor attachment comprising a connecting structure adapted for mounting over the trimmer onto the upper end, and a razor cartridge that mates with the connecting structure.

### CROSS REFERENCE TO RELATED APPLICATIONS

This application claims the benefit of U.S. Provisional Application No. 61/089,641 filed Aug. 18, 2008.

### FIELD OF THE INVENTION

The invention relates to a combination shaving and trimming device.

### BACKGROUND OF THE INVENTION

Most consumers find that dealing with multiple grooming tools like a razor, scissors and an electric trimmer every time they want to change the look of their facial hair can be a real hassle.

There is a need to provide a device which overcomes this practice of inconveniently handling multiple implements and combines a shaving and trimming device.

### SUMMARY OF THE INVENTION

In an aspect, the invention features a combination powered shaving and trimming device including a handle, a trimmer, a razor attachment, a first electrical arrangement and a second electrical arrangement. The handle has an upper end and lower end having the trimmer located at or near the upper end. The razor attachment includes a connecting structure and razor cartridge. The connecting structure is adapted for mounting over the trimmer onto the upper end. The razor cartridge engagably mates with the connecting structure. The first electrical arrangement is configured to supply power to the trimmer while the second electrical arrangement configured to supply power to the razor attachment. The first and second electrical arrangements may be separably operable.

In an aspect, the razor cartridge is removably attached to the connecting structure. In another aspect, the razor attachment includes an ejection mechanism for removably attaching the razor cartridge from the connecting structure. In another object, the razor cartridge includes one or more razor blades on a front surface and at least one blade disposed along a top surface of the cartridge and substantially perpendicular to the front surface.

In an implementation, the first electrical arrangement and second electrical arrangement may include a motor for powering the trimmer and razor attachment, respectively. In another object, the second electrical arrangement is disposed within razor attachment. The first electrical arrangement includes a first electrical contact and second electrical arrangement includes a second electrical contact. The second electrical contact is useful for engaging with the first electrical contact. Each of the electrical contacts may be a pressure sensor, an electrical sensor, a magnetic sensor, electromagnetic sensor, or combinations thereof. In an object, when the electrical contacts are disengaged, power is supplied to the trimmer and when the electrical contacts are engaged, power is supplied to the razor attachment.

The handle includes a switch. The switch is operably connected to at least one of the electrical arrangements. Actuating the switch selectively supplies power to the trimmer, the razor attachment, or both. In an implementation, the switch is a two-step switch. A first actuation of the switch supplies power to the trimmer and a second actuation of the switch supplies power to the razor attachment.

Another implementation includes a combination powered shaving and trimming device having a handle having a trimmer disposed adjacent one end; a razor attachment including a connecting structure adapted for mounting over the trimmer onto the handle; a razor cartridge a razor cartridge that mates with the connecting structure; a first electrical arrangement disposed in the handle and operably connected to the trimmer, such that the first electrical arrangement is configured to supply power to the trimmer; and a second electrical arrangement disposed within the handle and operably connected to the razor attachment, such that the second electrical arrangement is configured to supply power to the razor attachment, and the first electrical arrangement is separably operable from the second electrical arrangement.

In yet another implementation, a combination powered shaving and trimming device includes a handle including a trimmer disposed adjacent one end; a first electrical arrangement disposed in the handle and operably connected to the trimmer, such that the first electrical arrangement is configured to supply power to the trimmer; a razor attachment including a connecting structure adapted for mounting over the trimmer onto the handle; a razor cartridge mates with the connecting structure; a second electrical arrangement disposed in the razor attachment, such that the second electrical arrangement is configured to supply power to the razor attachment; and the first electrical arrangement is separably operable from the second electrical arrangement.

In another aspect, the combination device is impervious to liquids.

In a further another aspect, a cap is removably attached at the lower end.

The combination device provides for a powered trimmer for an all-in-one device no longer need for a separate trimmer and razor.

Other features and advantages of the invention will be apparent from the description and drawings, and from the claims.

### BRIEF DESCRIPTION OF THE DRAWINGS

FIG. 1 is a perspective view of a combination powered shaving and trimming device;

FIG. 2 is a perspective view of the separated shaving and trimming device of FIG. 1;

FIG. 3 is a perspective view of an alternative embodiment of a combination powered shaving and trimming device;

FIG. 4 is a perspective view of the separated shaving and trimming device of FIG. 3; and

FIG. 5 is a top perspective view of the combination powered shaving and trimming device.

### DETAILED DESCRIPTION OF THE INVENTION

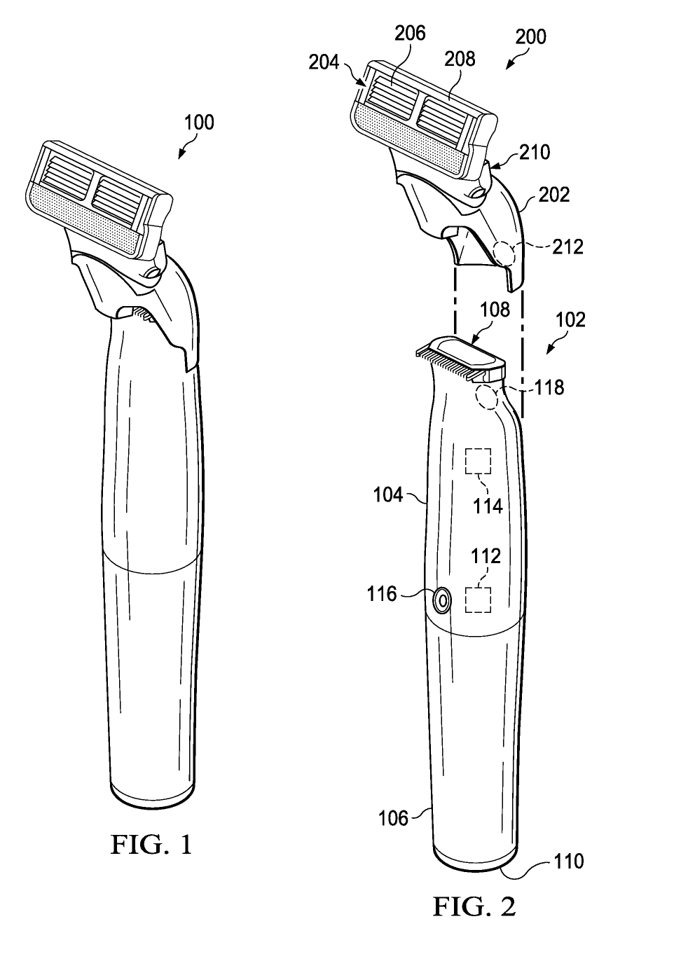

FIGS. 1 and 2 show a combination powered shaving and trimming device 100. Device 100 includes a handle 102, a trimmer 108, a razor attachment 200, a first electrical arrangement 112, and a second electrical arrangement 114. Device 100 is constructed such that the internal components of handle 102 and razor attachment 200, particularly the electrical components, are impervious to liquids. The handle 102 has an upper end 104 and lower end 106 and is adapted to being held by a user. In an embodiment, a cap 110 is removably attached at the lower end 106. The trimmer 108 is located at or near upper end 104 and is configured for moving at least one blade which is disposed within the trimmer 108.

The razor attachment 200 includes connecting structure 202 and razor cartridge 204. The connecting structure 202 is adapted for mounting over the trimmer 108 onto the upper end 104. The razor cartridge 204 engagably mates with the connecting structure 202. In this an embodiment, the razor cartridge 204 may be removably attached to the connecting structure 202.

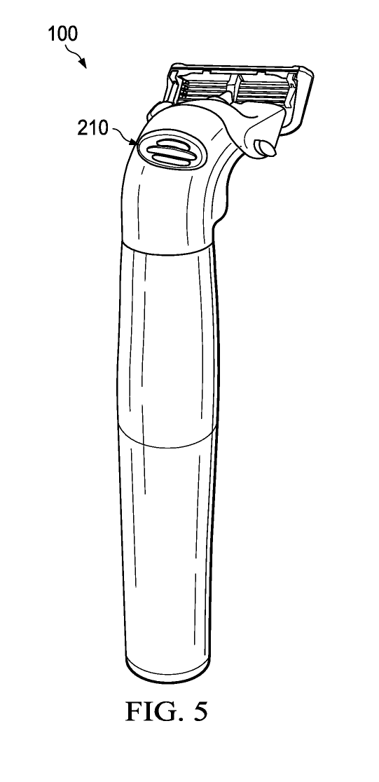

In another embodiment (not shown), the wet-shaving razor attachment 200 includes an ejection mechanism 210, shown in FIG. 5, for removably attaching the razor cartridge 204 from the connecting structure 202. In yet another embodiment, the razor cartridge 204 includes one or more razor blades 206 on a front surface and at least one blade 208 disposed along a top surface of the cartridge and substantially perpendicular to the front surface. The razor cartridge 204 can be of the type disclosed in U.S. Pat. No. 7,197,825 to Walker et al. and assigned to The Gillette Company.

Device 100 is constructed to be held by a user during operation, and to contain the components that provide the powered functionality. For example, device 100 may include a power source, a controller, a printed circuit board (“PCB”), a switch, and a light operatively connected to the PCB. The device 100 may be powered by various energy sources, including but not limited to, radiant, kinetic, potential, thermal, magnetic, gravitational, sound energy, light energy, electrical, electromagnetic, chemical source, and combinations thereof. The first electrical arrangement 112 is configured to supply power from a power source to the trimmer 108 and the second electrical arrangement 114 is configured to supply power from the power source to the razor attachment 200.

Device 100 is configured to operate as a powered trimming device, as shown in FIG. 2, or as a powered wet-shaving device, show in FIG. 1. In an embodiment, the combination device can function as a powered wet-shaving device by actuating trimmer 108 such that the resulting vibration from moving the at least one blade translates vibration to the razor attachment 200. When power is supplied to the first electrical arrangement 112, the trimmer functions as a powered trimmer moving at least one blade. When power is supplied to the second electrical arrangement 114, the razor attachment 200 functions as a powered wet-shaving razor causing vibration about the razor cartridge 204. In an embodiment, both the first electrical arrangement 112 and second electrical arrangement 114 are disposed in the handle 102. In another embodiment, the first electrical arrangement 312 is disposed in the handle 302 and the second electrical arrangement 412 is disposed in the razor attachment 200.

The first electrical arrangement 112, second electrical arrangement 114, or both may comprise a motor. Operation of either the first electrical arrangement 112 or second electrical arrangement 114 imparts vibration to the trimmer 108 or razor attachment 200. In an example, the first electrical arrangement 112 and second electrical arrangement 114 are operable independently of each other.

Device 100 includes a switch 116 disposed on the handle 102. The switch 116 is operably connected to at least one of the electrical arrangements 112, 114. Actuation of the switch selectively supplies power to the trimmer 108, the razor attachment 200, or both. In an example, the switch 116 is a two-step switch. A first actuation of the switch 116 supplies power to the trimmer while a second actuation of the switch 116 supplies power to the razor attachment 200.

In another embodiment, the first electrical arrangement 114 includes a first electrical contact 118 and second electrical arrangement 114 includes a second electrical contact 212 for engaging with the first electrical contact 118. Electrical contacts 118, 212 may be a pressure sensor, an electrical sensor, a magnetic sensor, electromagnetic sensor, or combinations thereof. Other suitable electrical contacts may be utilized. When the electrical contacts 118, 212 are disengaged, power is supplied to the trimmer. When the electrical contacts 118, 212 are engaged, power is supplied to the razor attachment.

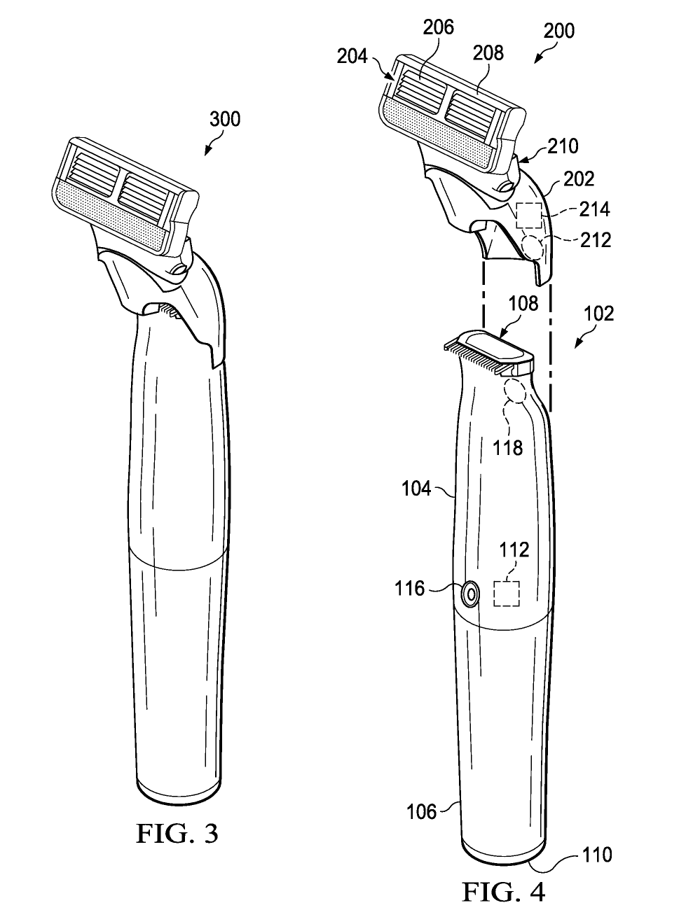

FIGS. 3 and 4 show another embodiment of a combination powered shaving and trimming device 300. Device 300 has similar features as device 100. Device 300 is configured to operate as a powered trimming device, as shown in FIG. 3, or as a powered wet-shaving device, show in FIG. 4. The first electrical arrangement 112 is configured to supply power to the trimmer 108 and the second electrical arrangement 214 is configured to supply power to the razor attachment 200. If power is supplied to the first electrical arrangement 112, the trimmer 108 functions as a powered trimmer moving at least one blade of the trimmer 108. If power is supplied to the second electrical arrangement 214, the razor attachment 200 functions as a powered wet-shaving razor causing vibration about the razor cartridge 204. The first electrical arrangement 112 is disposed in the handle 102 and the second electrical arrangement 212 is disposed in the razor attachment 200.

In this embodiment, the first electrical arrangement 112 includes a first electrical contact 118 and second electrical arrangement 214 includes a second electrical contact 212 for engaging with the first electrical contact 118. When the electrical contacts 118, 212 are disengaged, power is supplied to the trimmer. When the electrical contacts 318, 412 are engaged, power is supplied to the razor attachment. Electrical contacts may be of the type including, but not limited to, a pressure contact, an electrical contact, a magnetic contact, an electromagnetic contact, a mechanical contact, an inductive coupling, a capacitive coupling, or combinations thereof. Other suitable electrical contacts may be utilized.

For example, first electrical contact 118, second electrical contact 212, or both may be a microswitch. The microswitch may be a normally closed or normally open switch having an engagable toggle member and is electrically coupled to the first electrical arrangement 112, second electrical arrangement 214 or both. When the toggle member is disengaged, the microswitch is in an “open” state (e.g., open for a normally closed microswitch) providing for power to the trimmer 108. When the toggle member is engaged, the microswitch is in a “closed” state providing for power to the razor attachment 200. Alternatively, first electrical contact 118, second electrical contact 212, or both may include a magnetic member and a reed switch electrically coupled to the first electrical arrangement 112, second electrical arrangement 214 or both. As the magnetic field changes, the reed switch is changed from an “open” state, i.e. providing for power to the trimmer 108, to a “closed” state, i.e. providing for power to the razor attachment 200.

In another example, first electrical contact 118, second electrical contact 212, or both may be a PCB having electrodes thereon. The electrode on the first electrical contact 118 is interlaced with but not couple with the electrode on the second electrical contact 212. A resistive member electrically contacts but does not electrically couple the electrodes. The resistive member may be pressure sensitive such that when under pressure the electrodes are electrically connected. Alternatively, if pressure is applied to the resistive member, then a change in voltage is produced. In another example, the resistive member may be formed from a pressure sensitive polymer, metallic particles, a semi-conductive material, combinations thereof, or other materials suitable for the intended purpose.

In another embodiment, the razor attachment 200 includes an energy storage device, e.g., coin cell, double layer capacitor, solar cell, or other suitable storage device for storing energy to operate the second electrical arrangement 212. In an example, the energy storage can be configured to provide inductive charging via an external charging station. The charging station can be part of the trimmer or part of another external charging station on which the attachment is placed when it is not attached. In another embodiment, razor attachment includes a switch to separably operate the second electrical arrangement 212 upon attachment.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combination powered shaving and trimming device comprising:
a handle having an upper end and lower end;
a trimmer disposed adjacent the upper end;
a razor attachment comprising:
a connecting structure adapted for mounting over the trimmer onto the upper end; and
a razor cartridge that mates with the connecting structure;
a first electrical arrangement disposed in the handle wherein the first electrical arrangement is configured to supply power to the trimmer; and
a second electrical arrangement configured to supply power to the razor attachment.

2. The device of claim 1 wherein the lower end comprises a removably attached cap.

3. The device of claim 1 wherein the razor cartridge is removably attached to the connecting structure.

4. The device of claim 1 wherein the razor attachment further comprises an ejection mechanism.

5. The device of claim 1 wherein the device is impervious to liquids.

6. The device of claim 1 wherein the razor cartridge further comprises one or more razor blades on a front surface and at least one blade disposed along a top surface of the cartridge and substantially perpendicular to the front surface.

7. The device of claim 1 wherein one or both of the first electrical arrangement and second electrical arrangement further comprise a motor.

8. The device of claim 1 wherein the second electrical arrangement is disposed in the razor attachment.

9. The device of claim 1 wherein the first electrical arrangement and second electrical arrangement are separably operable.

10. The device of claim 1 further comprising a switch disposed on the handle.

11. The device of claim 10 wherein the switch is operably connected to at least one of the electrical arrangements, whereby actuating the switch selectively supplies power to the trimmer, the razor attachment, or both.

12. The device of claim 11 wherein the switch is a two-step switch, whereby a first actuation of the switch supplies power to the trimmer and a second actuation of the switch supplies power to the razor attachment.

13. The device of claim 1 wherein the first electrical arrangement further comprises a first electrical contact and second electrical arrangement further comprises a second electrical contact for engaging with the first electrical contact.

14. The device of claim 13 wherein each of the first and/or second electrical contacts is selected from the group consisting of a pressure contact, an electrical contact, a magnetic contact, an electromagnetic contact, a mechanical contact, an inductive coupling, a capacitive coupling, and combinations thereof.

15. The device of claim 13 wherein when the electrical contacts are disengaged, power is supplied to the trimmer and when the electrical contacts are engaged, power is supplied to the razor attachment.

16. A combination powered shaving and trimming device comprising:
a handle having a trimmer disposed adjacent one end;
a razor attachment comprising:
a connecting structure adapted for mounting over the trimmer onto the handle; and
a razor cartridge that mates with the connecting structure;
a first electrical arrangement disposed in the handle and operably connected to the trimmer, wherein the first electrical arrangement is configured to supply power to the trimmer; and
a second electrical arrangement disposed in the handle and operably connected to the razor attachment, wherein the second electrical arrangement is configured to supply power to the razor attachment,
wherein the first electrical arrangement is separably operable from the second electrical arrangement.

17. A combination powered shaving and trimming device comprising:
a handle comprising:
a trimmer disposed adjacent one end; and
a first electrical arrangement disposed in the handle and operably connected to the trimmer, wherein the first electrical arrangement is configured to supply power to the trimmer;
a razor attachment comprising:
a connecting structure adapted for mounting over the trimmer onto the handle;
a razor cartridge that mates with the connecting structure; and
a second electrical arrangement disposed in the razor attachment, wherein the second electrical arrangement is configured to supply power to the razor attachment;
wherein the first electrical arrangement is separably operable from the second electrical arrangement.

18. The device of claim 17 wherein the first electrical arrangement further comprises a first electrical contact and second electrical arrangement further comprises an electrical contact for engaging with the first electrical contact.

19. The device of claim 18 wherein the electrical contact is selected from the group consisting of a pressure contact, an electrical contact, a magnetic contact, an electromagnetic contact, a mechanical contact, an inductive coupling, a capacitive coupling, and combinations thereof.

20. The device of claim 18 wherein when the electrical contacts are disengaged, power is supplied to the trimmer and when the electrical contacts are engaged, power is supplied to the razor attachment.
